(19) United States
(12) Patent Application Publication
(10) Pub. No.: US 2025/0238826 A1
(43) Pub. Date: Jul. 24, 2025

(54) PURCHASE ACTION ANALYSIS APPARATUS, PURCHASE ACTION ANALYSIS METHOD, AND COMPUTER READABLE MEDIUM

(71) Applicant: NEC Corporation, Tokyo (JP)

(72) Inventors: Shinya KOUYAMA, Tokyo (JP); Motonori IKEUCHI, Tokyo (JP); Takahiro MURAMATSU, Tokyo (JP)

(73) Assignee: NEC Corporation, Tokyo (JP)

(21) Appl. No.: 19/010,329

(22) Filed: Jan. 6, 2025

(30) Foreign Application Priority Data
Jan. 19, 2024 (JP) 2024-006634

(51) Int. Cl. G06Q 30/0202; G06Q 20/38

(52) U.S. Cl. CPC G06Q 30/0202; G06Q 20/389

(57) ABSTRACT

A generation unit of the purchase action analysis apparatus generates, using purchase history information including an entity who has purchased a product, a timing at which the product has been purchased, and a purchase amount of the product, purchase status information including information about a total purchase amount that is a total amount of purchase amount by the entity in each analysis unit period. An identification unit identifies, as a change factor, a product or a product classification that is a factor of a change in the purchase status of the entity whose purchase status has changed, using the purchase history information and the purchase status information. The output unit outputs change factor information indicating the identified change factor.

This application is based upon and claims the benefit of priority from Japanese Patent Application No. 2024-006634, filed on Jan. 19, 2024, the disclosure of which is incorporated herein in its entirety by reference.

### TECHNICAL FIELD

The present disclosure relates to a technique for analyzing a customer's purchase action.

### BACKGROUND ART

Various marketing strategies have been developed to increase retail business sales. For example, Reference Literature 1 (JP 2017-220155 A) discloses the following marketing strategy. That is, in the marketing strategy described in Reference Literature 1, sales promotion measures are implemented in which a customer is periodically ranked using the data of the purchase amount, the number of purchases, and the last purchase date of the customer acquired from the e-commerce site, and the mail for sales promotion according to the rank is transmitted to the customer.

In the marketing strategy as described above, sales promotion measures using information about the rank of the customer are implemented. Such information about the rank of the customer is considered to be useful information when developing a marketing strategy, but when considering developing a marketing strategy, information from a new viewpoint is desired.

### SUMMARY

A main object of the present disclosure is to provide a technology capable of providing information from a new viewpoint that can contribute to planning of a marketing strategy.

In an aspect of a purchase action analysis apparatus according to the present disclosure, the a purchase action analysis apparatus includes a memory configured to store instructions, and at least one processor configured to execute the instructions to, generate, using purchase history information including an entity who has purchased a product, a timing at which the product has been purchased, and a purchase amount of the product, purchase status information including information about a total purchase amount that is a total amount of one or more purchase amounts of the entity in each analysis unit period, identify, as a change factor, a product or a product classification that is a factor of a change in a purchase status of an entity whose purchase status has changed, using the purchase history information and the purchase status information, and output change factor information representing the identified change factor.

In an aspect of a purchase action analysis method according to the present disclosure, the purchase action analysis method executed by a computer includes generating, using purchase history information including an entity who has purchased a product, a timing at which the product has been purchased, and a purchase amount of the product, purchase status information including information about a total purchase amount that is a total amount of one or more purchase amounts of the entity in each analysis unit period, identifying, as a change factor, a product or a product classification that is a factor of a change in a purchase status of an entity whose purchase status has changed, using the purchase history information and the purchase status information, and outputting change factor information representing the identified change factor.

In an aspect of a non-transitory computer readable medium according to the present disclosure, the non-transitory computer readable medium stores a computer program for causing a computer to execute generate, using purchase history information including an entity who has purchased a product, a timing at which the product has been purchased, and a purchase amount of the product, purchase status information including information about a total purchase amount that is a total amount of one or more purchase amounts of the entity in each analysis unit period, identify, as a change factor, a product or a product classification that is a factor of a change in a purchase status of an entity whose purchase status has changed, using the purchase history information and the purchase status information, and output change factor information representing the identified change factor.

### BRIEF DESCRIPTION OF THE DRAWINGS

Exemplary features and advantages of the present invention will become apparent from the following detailed description when taken with the accompanying drawings in which:

FIG. 1 is a diagram for describing an example embodiment of a purchase action analysis apparatus according to the present disclosure;

FIG. 2 is a diagram illustrating an example of purchase history information;

FIG. 3 is a diagram illustrating an example of customer attribute information;

FIG. 4 is a diagram illustrating an example of customer rank history information;

FIG. 5 is a diagram illustrating an example of a rank determination criterion;

FIG. 6 is a diagram illustrating an example of purchase status information;

FIG. 7 is a diagram for describing a method of selecting learning data to be used for model learning;

FIG. 8 is a diagram for describing another method of selecting learning data to be used for model learning;

FIG. 9 is a diagram illustrating an example of a display mode for displaying a change factor;

FIG. 10 is a diagram illustrating still another example of a display mode for displaying a change factor;

FIG. 11 is a diagram illustrating an example of a display mode for displaying the transition of a purchase factor;

FIG. 12 is a diagram for describing another example of the information output from an output unit;

FIG. 13 is a diagram for describing another example of the information output from the output unit;

FIG. 14 is a flowchart illustrating an example of an operation in the example embodiment of the purchase action analysis apparatus;

FIG. 15 is a diagram illustrating another example of an output destination to which information is output from the purchase action analysis apparatus;

FIG. 16 is a diagram for describing an example embodiment of a purchase action analysis system;

FIG. 17 is a diagram for describing a configuration example of a computer device constituting the purchase action analysis system;

FIG. 18 is a diagram for describing another example embodiment;

FIG. 19 is a diagram illustrating a display example of information output from the output unit;

FIG. 20 is a diagram for describing another example embodiment of the purchase action analysis apparatus according to the present disclosure; and

FIG. 21 is a flowchart illustrating another example of the operation of the purchase action analysis apparatus.

### EXAMPLE EMBODIMENT

Hereinafter, example embodiments according to the present disclosure will be described with reference to the drawings.

### First Example Embodiment

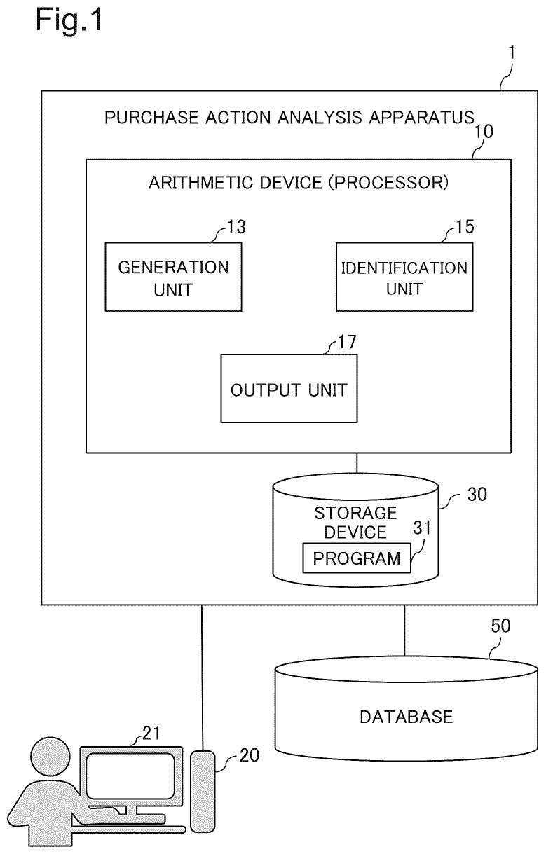

A purchase action analysis apparatus according to the first example embodiment of the present disclosure is a computer device (for example, a server), and has a function of analyzing a purchase action of a customer and providing information based on an analysis result to a user. As illustrated in FIG. 1, a purchase action analysis apparatus 1 of the first example embodiment is connected to a terminal device 20. The terminal device 20 is an information device (computer device), and has a communication function, an information reception function, and a display control function. The communication function is a function of communicating information with a communication apparatus (apparatus with a communication function) directly or indirectly connected via an information communication network. The information reception function is a function of receiving information input using an input device such as a keyboard, a mouse, or a touch panel. The display control function is a function of causing a display device 21 to display information on a screen. A type of the terminal device 20 is not limited as long as it is an information device having a communication function, an information reception function, and a display control function, and specific examples thereof include a personal computer, a smartphone, a tablet, and the like. When the terminal device 20 is a personal computer, the display device 21 may be externally attached, but when the terminal device 20 is a smartphone or a tablet, the display device 21 is integrated with the terminal device 20.

The terminal device 20 inputs information to the purchase action analysis apparatus 1 and displays information output from the purchase action analysis apparatus 1 on the display device 21 using the communication function, the information reception function, and the display control function. That is, the user of the purchase action analysis apparatus 1 inputs information to the purchase action analysis apparatus 1 or acquires information output from the purchase action analysis apparatus 1 from the screen display of the display device 21 using the terminal device 20. The user of the purchase action analysis apparatus 1 may be, for example, a person who sets up a marketing strategy, or may be a person who provides an analysis result of the purchase action analysis apparatus 1 to a person who sets up a marketing strategy.

In the example of FIG. 1, there is one terminal device 20 connected to the purchase action analysis apparatus 1, but there may be a plurality of terminal devices 20 connected to the purchase action analysis apparatus 1, and the number of terminal devices 20 connected is not limited.

The purchase action analysis apparatus 1 is also connected to a database 50. The database 50 is a storage medium (storage device) that stores data (information). Data (information) used for processing by the purchase action analysis apparatus 1 and data (information) generated by the processing by the purchase action analysis apparatus 1 are stored in the database 50. For example, the database 50 stores purchase history information as information to be used for processing by the purchase action analysis apparatus 1.

The purchase history information is information including an entity who has purchased the product, a timing at which the product has been purchased, and a purchase amount of the product in association with each other. The product is a product to be bought and sold, and includes not only articles such as food and clothes but also services such as distribution services and consultation services, information to be bought and sold (for example, information provided via the Internet), and rights (for example, rights to receive services).

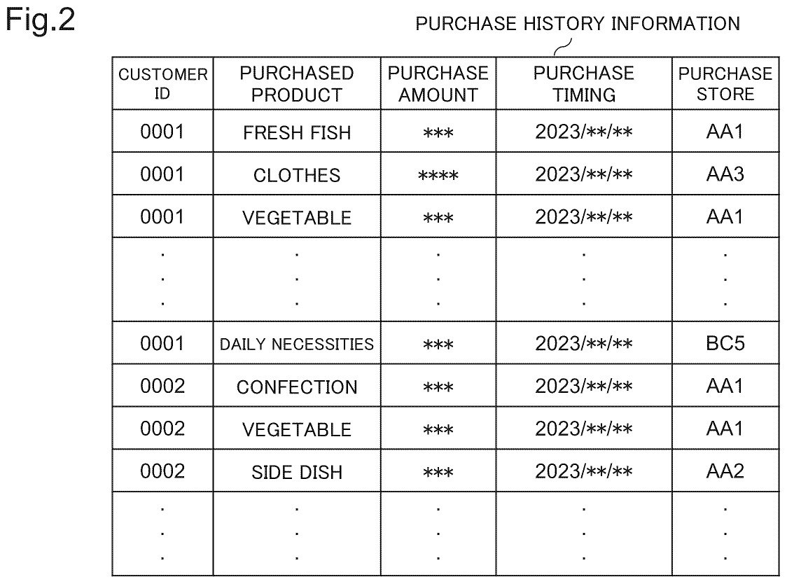

FIG. 2 illustrates an example of purchase history information. In the example illustrated in FIG. 2, the purchase history information includes customer identification (ID), purchased product information, purchase amount information, purchase timing information, and purchase store information. The customer ID is information representing a customer who is an entity who has purchased the product, and is information such as an identification number assigned to each customer to identify the customer. In the example of FIG. 2, the customer ID is exemplified as the identification information about the customer, but for example, the identification information about the customer may be any information that can identify the customer, and may be, for example, a name other than the customer ID.

The purchased product information is information indicating a product purchased by the customer. The purchased product information may be, for example, information indicating a name of a product or information indicating a category (classification) of a product. The purchase amount information is information indicating the purchase amount of the product indicated in the purchased product information. The purchase timing information is information indicating a timing at which the customer purchased the product indicated in the purchased product information, and is, for example, information indicating a purchase date. The purchase store information is information indicating a store at which the customer has purchased the product indicated in the purchased product information. The purchase store information may be, for example, a name of the purchase store or an identification number (store number) as long as the purchase store can be identified, and is not limited thereto. It is also assumed that the purchase store includes an electronic commerce (EC) site on the Internet.

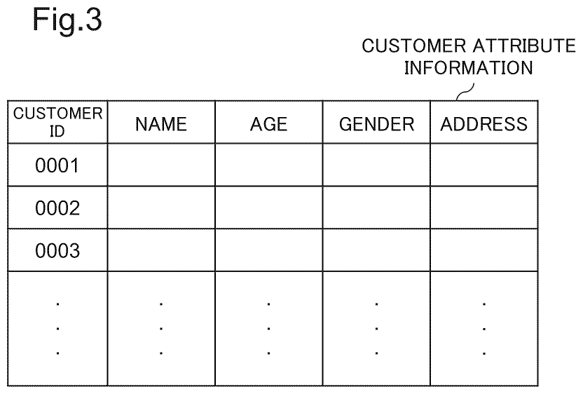

The database 50 further stores, for example, customer attribute information as information used for processing by the purchase action analysis apparatus 1. The customer attribute information is information indicating the attribute of the customer, and includes attribute information indicating the name, age, gender, and address of the customer in the example of FIG. 3, and these pieces of attribute information are associated with the customer ID. The customer attribute information may include, for example, attribute information of a customer appropriately determined in consideration of a marketing strategy, and is not limited to the example of FIG. 3.

The method of acquiring the purchase history information and the customer attribute information about the customer as described above, the control procedure of storing the acquired information in the database 50, and the like are not limited and thus the description thereof will be omitted.

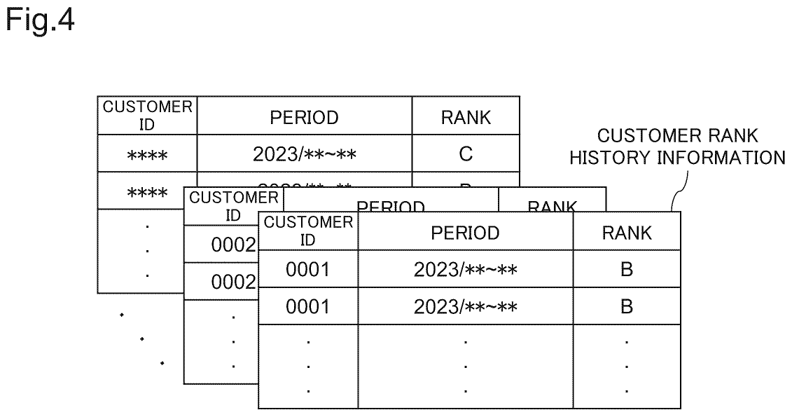

The database 50 further stores customer rank history information. The customer rank history information is, for example, information indicating a history of ranks for each customer as illustrated in the image diagram of FIG. 4. The rank is information indicating the evaluation of the customer determined (decided) from the purchase action. The method of determining the rank is not limited as long as it is a method using information related to the purchase action, but as an example, there is a method of ranking the customers using a rank determination criterion given in advance.

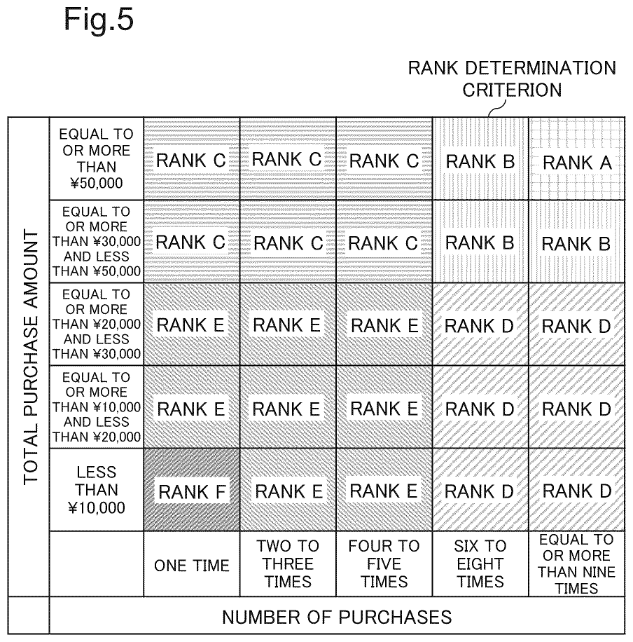

For example, a rank determination criterion as illustrated in FIG. 5 is given as the rank determination criterion. In the example of FIG. 5, the rank determination criterion is a criterion for ranking the rank of the customer into any one of Ranks A to F using the number of times of purchasing the products (the number of purchases) and the total amount (total purchase amount) of the purchase amount of the products for each preset rank determination period (for example, in units of three months). In the example of FIG. 5, the rank is high in the order from F, E, D, C, B, to A where A is the highest. The ranking of customers is performed, for example, for a store (hereinafter, also referred to as a store of interest) focused on in order to formulate a marketing strategy. The store of interest here may be one store. For example, when the same owner manages a plurality of stores of the same type, the plurality of stores may be collectively regarded as one store of interest.

For example, the purchase action analysis apparatus 1 calculates, for each customer, from the purchase history information, information about the number of purchases the customer purchased the products at the store of interest and the total purchase amount which is the total amount of the purchase amount in the rank determination period. Further, the purchase action analysis apparatus 1 determines a rank for each customer using the number of purchases, the total purchase amount, and the rank determination criterion calculated for each customer, and adds information indicating the determined rank to the customer rank history information in the database 50. For example, it is assumed that for a certain customer, it was calculated that the number of purchases at the store of interest was three times and the total purchase amount was 22,000 yen in the rank determination period. In this case, the customer is determined to have a rank of “E” based on the rank determination criterion in FIG. 5. There are various methods for ranking customers, and the method is not limited to the above-described ranking method, and information used for ranking is not limited to the above-described example. For example, there is a method of ranking customers only by information of the total purchase amount.

As described above, the database 50 stores various pieces of information related to the processing of the purchase action analysis apparatus 1.

As illustrated in FIG. 1, the purchase action analysis apparatus 1 includes an arithmetic device 10 and a storage device 30. The storage device 30 includes a storage medium that stores data and a computer program (hereinafter, also referred to as a program for short) 31. There is a plurality of types of storage devices such as a magnetic disk device and a semiconductor memory element, and there is a plurality of types of semiconductor memory elements such as a random access memory (RAM) and a read only memory (ROM). The computer device includes a plurality of storage devices having different uses. The type and number thereof are not limited and the description thereof will be omitted. It is assumed that a plurality of storage devices included in a computer device is collectively referred to as the storage device 30 without distinction.

The arithmetic device 10 includes a processor such as a central processing unit (CPU) or a graphics processing unit (GPU). The arithmetic device 10 can have various functions based on the program 31 by reading and executing the program 31 stored in the storage device 30. The purchase action analysis apparatus 1 includes a generation unit 13, an identification unit 15, and an output unit 17 as functional units related to the purchase action analysis.

Generation unit 13 generates purchase status information for each customer using the purchase history information stored in database 50. The purchase status information is information including information about the total purchase amount in each analysis unit period set in advance. An examples of the analysis unit period includes the above-described rank determination period (for example, in units of three months). In this case, as a specific example of the purchase status information, there is information including history information of the total purchase amount in each rank determination period such that the total purchase amount for three months (rank determination period) from January to March is *** yen, and the total purchase amount for three months from April to June is *** yen.

The generation unit 13 ranks each customer as described above based on the purchase action in the rank determination period (analysis unit period). The generation unit 13 includes information about the rank for each customer in the rank determination period (analysis unit period) determined by the ranking processing in the purchase status information.

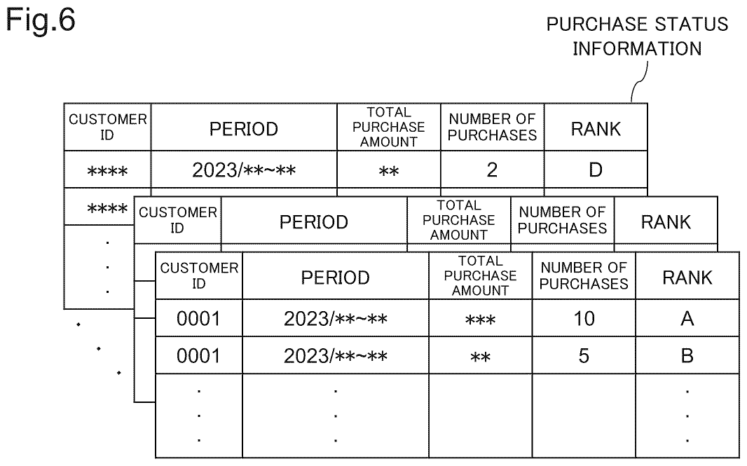

Furthermore, depending on the ranking method, the generation unit 13 may include information (for example, information about the number of purchases in the rank determination period (analysis unit period)) used for ranking other than the total purchase amount in the purchase status information as illustrated in FIG. 6.

The timing at which the generation unit 13 generates the purchase status information as described above is, for example, a timing triggered by reception of an analysis start command from the terminal device 20 connected to the purchase action analysis apparatus 1. After the purchase status information is generated by the generation unit 13, for example, the purchase status information may be updated by the generation unit 13 every time the analysis unit period elapses.

Using the purchase history information and the purchase status information, the identification unit 15 identifies, as a change factor, a product or a product classification that is a factor of a change in the purchase status of the customer whose purchase status has changed. As a specific example, the identification unit 15 refers to the information about the rank included in the purchase status information and groups the customers in the store of interest according to the change tendency of the rank. Examples of the group herein include a group of customers whose rank is raised from B to A and a group of customers whose rank is lowered from C to D in the analysis unit period (rank determination period). Another example of the group may include a group of customers whose rank is raised from D to B, and a group of customers whose rank was D in the previous ranking and other than B in the current ranking. In other words, grouping may be made in such a way that the ranks in the previous ranking was set to the same, and the ranks in the current ranking are set to a rank of interest (the rank of interest) and a rank other than the rank of interest.

The identification unit 15 identifies, as a change factor, a product or a product classification that is a factor of a change in the purchase status in the analysis unit period for the group as described above, thereby identifying a change factor in the analysis unit period of the customer included in the group. Which of the product and the product classification the identification unit 15 identifies as the change factor is set by, for example, a device designer or the like in consideration of a request from a user of the purchase action analysis apparatus 1 (a person who receives provision of information based on an analysis result from the purchase action analysis apparatus 1). Which of the product and the product classification the identification unit 15 identifies as the change factor is appropriately set as described above and is not limited, but in the following description, the product classification is identified in order to avoid complication of description. In the following description, the product classification that is a factor of a change in the total purchase amount of the customer is also referred to as a change factor. Furthermore, one change factor is not necessarily identified as a change factor in the analysis unit period, and a plurality of change factors may be identified.

An example of a method in which the identification unit 15 identifies a change factor is a method using an artificial intelligence (AI) technology. In this method, a change factor identification model is used. An example of the change factor identification model is a model in which the purchase history information of a customer included in the group as described above and the attribute information about the customer are used as inputs, and the information of the change factor is output.

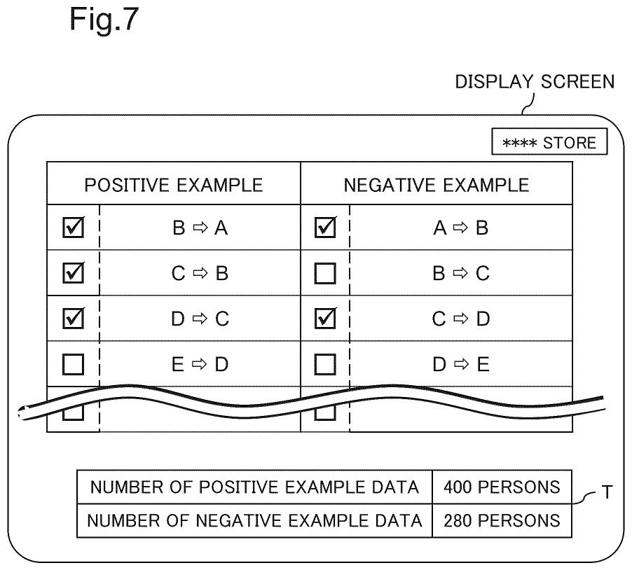

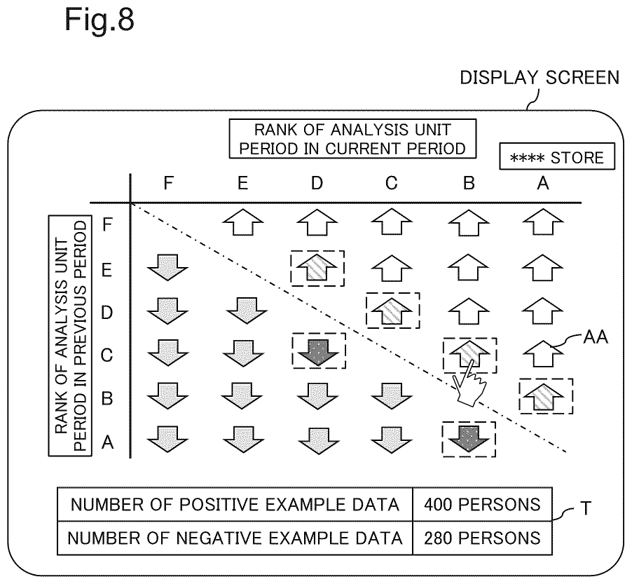

The change factor identification model is generated by machine learning using the purchase history information about the customer as learning data. For example, in order to select the learning data of the change factor identification model, a screen for selecting the learning data as illustrated in FIGS. 7 and 8 is displayed on the display device. In the examples of FIGS. 7 and 8, six ranks in which the rank is raised in the order from F, E, D, C, B, to A where A is the highest rank as described above are set. In the example of FIG. 7, classification items (for example, a classification item in which the rank is raised from the Rank B to Rank A (hereinafter, it is also referred to as a rank change classification item)) for classifying the rank change tendency are listed by characters. In the example of FIG. 8, the rank change classification items are represented using symbols (arrows). For example, an upward arrow AA illustrated in FIG. 8 represents a classification item in which the rank is raised from the Rank C to the Rank A. A downward arrow represents a classification item in which the rank is lowered.

Each of the plurality of pieces of purchase history information as the learning data candidates is classified into any one of the rank change classification items as described above using the rank determination period and the history of the rank indicated in the purchase status information of the related customer.

A display field T for the number of selected data is further displayed on the screen for selecting learning data as illustrated in FIGS. 7 and 8. The display field T for the number of selected data is a screen display portion representing the number of each of the positive example data and the negative example data selected as the learning data. The positive example data is purchase history information about an entity whose purchase status indicates a noted change (for example, a noted change such as a change from the Rank C to the Rank D). The negative example data is purchase history information about an entity whose purchase status indicates a change other than the noted change (for example, an entity in which the change is not noted such as a change from the Rank C to the Rank D).

For example, it is assumed that a system designer or the like selects (designates) a rank change classification item (change of a rank of interest) of a learning data candidate desired to be used for the change factor identification model learning using a learning data selection screen. As a result, the number of each of the positive example data and the negative example data to be displayed in the display field T for the number of selected data is calculated, and the number of calculation results is displayed in the display field T. In the example of FIG. 7, the check box is checked for the selected rank change classification item. In the example of FIG. 8, the arrow representing the selected rank change classification item is displayed by changing, for example, the color or filling pattern as an arrow surrounded by a dotted frame.

The identification unit 15 identifies the change factor in the analysis unit period for the group as described above using the change factor identification model as described above, thereby identifying the change factor in the analysis unit period of the customer included in the group.

The identification unit 15 may execute the following identifying process. The identifying process is a process of identifying, as a purchase factor, a product or a product classification estimated to have led to the customer's purchase action for each of the plurality of sectional periods set in the analysis unit period. The plurality of sectional periods set in the analysis unit period may be periods obtained by dividing the analysis unit period at equal intervals, or may be a plurality of sectional periods appropriately designated according to a matter desired to be analyzed by a system designer or the like. The method of setting the sectional period is not limited. As described above, the method of setting the sectional period is not limited, but as a specific example, the sectional period is set such that one week centered on a day one week before the end point of the analysis unit period is set as one sectional period, and one week centered on a day two weeks before the end point of the analysis unit period is set as one sectional period.

The identification unit 15 identifies the purchase factor estimated to have led to the purchase action of the customer belonging to the group as described above in each sectional period set in such a manner. An example of the method of identifying the purchase factor includes an AI technology similar to the AI technology used in the method of identifying the change factor.

The identification unit 15 stores the information about the change factor and the purchase factor identified as described above in the database 50 in association with the information for identifying the relevant group and the information indicating the analysis unit period or the sectional period.

The output unit 17 outputs information indicating the change factor identified by the identification unit 15 as change factor information. The output unit 17 outputs the information about the purchase factor identified by the identification unit 15 as the purchase factor information. The output destination is, for example, the terminal device 20 connected to the purchase action analysis apparatus 1, and the output timing is, for example, a timing triggered by reception of an information provision request from the terminal device 20. The information provision request is a command for requesting information provision, and target person information, type information, and target period information are associated with the information provision request. T The target person information is information indicating a group related to the information requested to be provided. The type information is information indicating the type of information requested to be provided. The types of information include types of information such as change factor information (that is, information indicating a change factor in the analysis unit period) and purchase factor information (that is, information indicating purchase factors of the plurality of sectional periods in the analysis unit period). The target period information is information indicating an analysis unit period of the requested information.

For example, it is assumed that the analysis unit period is April to June in the year ***, and the purchase factor information about the group of customers whose rank is raised from D to B due to the purchase action in the analysis unit period is requested. In this case, the target period information associated with the information provision request is information indicating an analysis unit period of April to June in the year ***. The target person information is information indicating a group of customers whose rank is raised from D to B due to the purchase action in the analysis unit period. Further, the type information is information for identifying the purchase factor information.

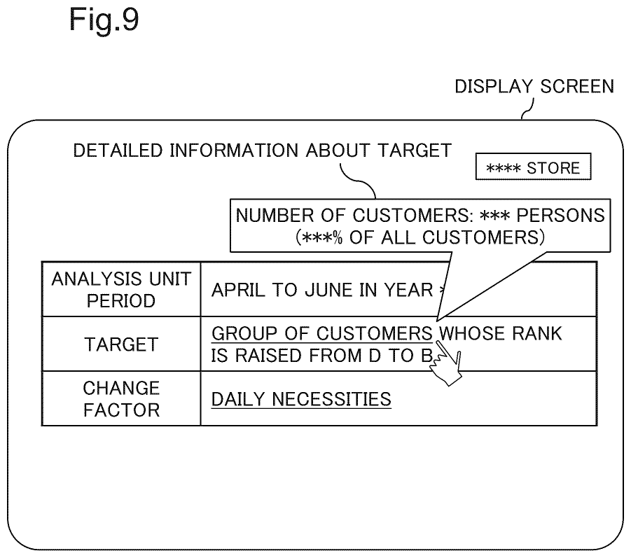

Upon receiving the information provision request from the terminal device 20, the output unit 17 searches the database 50 for information about the information provision target using the target person information, the type information, and the target period information associated with the information provision request. The output unit 17 reads the searched information from the database 50 and returns the information to the terminal device 20 of the transmission source of the information provision request. The terminal device 20 displays the change factor information or the purchase factor information received from the purchase action analysis apparatus 1 on the screen of the display device 21. The display mode of displaying the change factor information and the purchase factor information on the screen is not limited as long as it is a display mode in consideration of easiness of viewing and ease of understanding of the information, but specific examples are illustrated in FIGS. 9 to 14.

For example, FIG. 9 is a diagram illustrating an example of a display mode of the change factor information. In the example of FIG. 9, the change factor information is information about a group of customers whose rank has been raised from D to B due to the purchase action in the analysis unit period. The information about the change factor included in the change factor information is represented in the form of a table (alternatively, it is also referred to as a list.). In the example of FIG. 9, the change factor information is associated with an image representing a change factor and detailed information about a target group. For example, when an information reading portion in which link information for calling such an image or detailed information is set is designated on the display screen, the detailed information about the group is displayed.

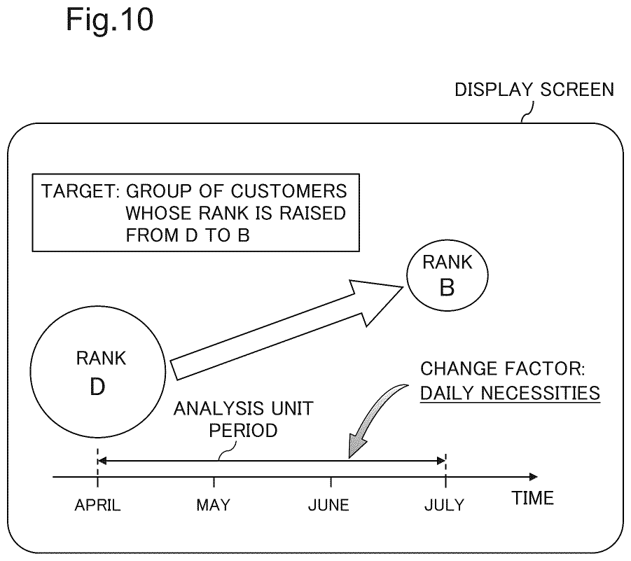

FIG. 10 is a diagram illustrating still another example of the display mode of the change factor information. FIG. 10 schematically illustrates the change factor information. FIG. 10 is a diagram related to change factor information of a group of customers whose rank is raised from D to B due to purchase action in an analysis unit period. In the example of FIG. 10, as in the example of FIG. 9, the detailed information about the group can be displayed.

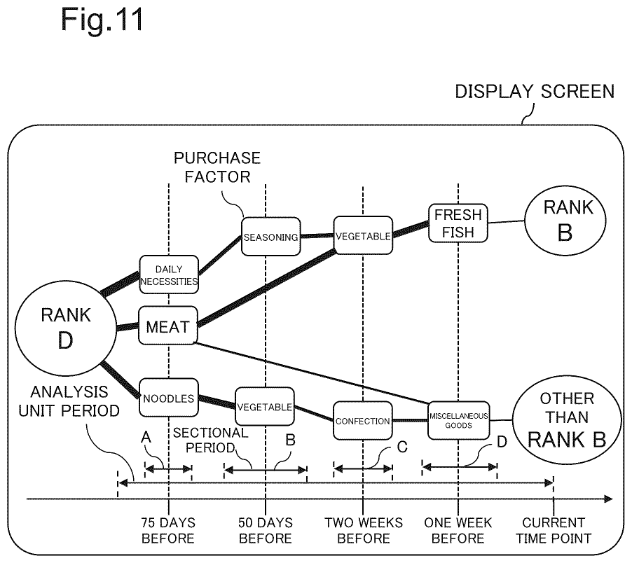

FIG. 11 is a diagram illustrating an example of a display mode of displaying the purchase factor information. The groups illustrated in the example of FIG. 11 are a group whose rank is raised from D to B and a group whose rank is changed from D to a rank other than B due to the purchase action in the analysis unit period. For those groups, a purchase factor is identified in each of a plurality of sectional periods set in the analysis unit period, and in the example of FIG. 11, a character mark indicating the identified purchase factor is disposed in time series. That is, in the example of FIG. 11, the purchase factor information is displayed in a mode of a purchase factor time series pattern in which the purchase factors are disposed in time series. In the example of FIG. 11, the thickness of the line connecting the marks of the purchase factor disposed in such a manner represents a thickness related to the number of people. That is, the number of customers (the number of entities) having the same combination of purchase factors in the sectional periods temporally adjacent to each other is represented by the thickness of the line. The thickness of the line increases as the number of customers increases. That is, in this example, the purchase factor information output by the output unit 17 includes information indicating the number of entities having the same combination of adjacent purchase factors.

Furthermore, in the example of FIG. 11, regarding the customers whose rank according to the purchase action in the previous analysis unit period was D, product classifications of daily necessities, noodles, and meat are identified as main purchase factors in the sectional period A centered on a day 75 days before the current time point. Furthermore, it is indicated that, for customers in which meat was a purchase factor, the purchase factor in the next sectional period B (that is, a sectional period centered on a day 50 days before the current time point.) is not identified. Further, the example of FIG. 11 illustrates that many customers in which meat was a purchase factor in the sectional period A follow any of the transitions of two purchase factors indicated below. That is, one of the transitions of the purchase factors is a transition in which the purchase factor in the sectional period A is meat, the purchase factor in the sectional period C (that is, a sectional period centered on a day two weeks before the current time point) is vegetables, and the rank at the current time point is raised to B. Another transition of the purchase factor is a transition in which the purchase factor in the sectional period A is meat, and the purchase factor in the sectional period D (that is, a sectional period centered on a day one week before the current time point) is miscellaneous goods, and the rank at the current time point is a rank other than B. The purchase factor information output from the purchase action analysis apparatus 1 to the terminal device 20 includes information necessary for displaying the information such that the information about the number of people related to the thickness of the line connecting the marks of the purchase factor illustrated in FIG. 11 is included in the purchase factor information.

In FIG. 11, information about the number of people indicated by the thickness of the line connecting the marks of the purchase factor may be displayed. Furthermore, the purchase factor information may be displayed in a form of a table or a list instead of the schematic diagram as illustrated in FIG. 11.

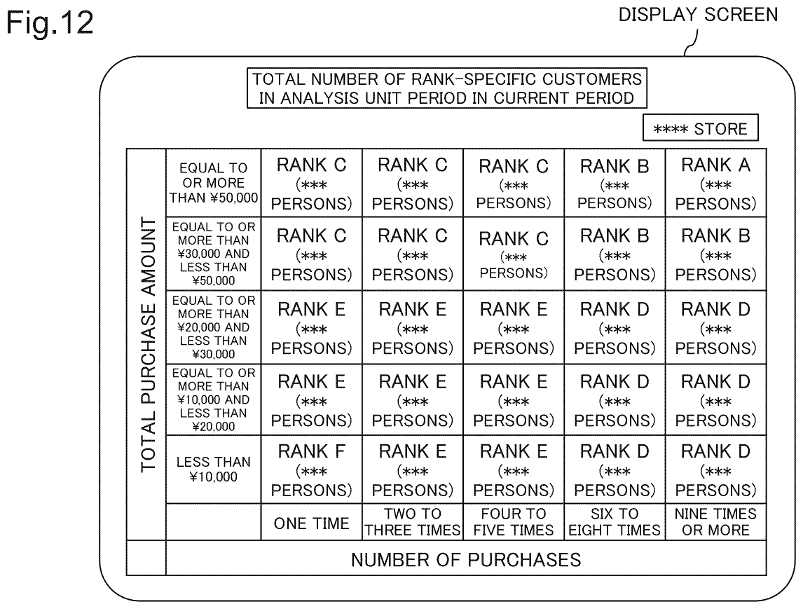

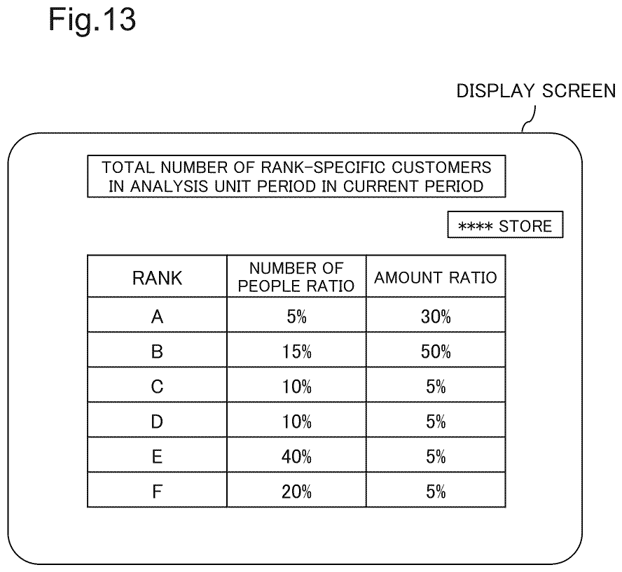

The output unit 17 may further output the following information based on the purchase status information generated by the generation unit 13 to, for example, the terminal device 20. The information based on the purchase status information is, for example, aggregated information about the rank of the customer in the store of interest. Such aggregated information is output to the terminal device 20, for example, according to a request, and is displayed on the display device 21 by display control of the terminal device 20. FIGS. 12 and 13 illustrate specific examples of the aggregated information. In the example of FIG. 12, the aggregated information is information indicating the total number of customers ranked in a certain analysis unit period in the store of interest, and the aggregated information is displayed on the screen in the form of a table. In the example of FIG. 13, the aggregated information includes, for a certain analysis unit period, a ratio of the number of customers based on the rank to the total number of customers of the store of interest (ratio of the number of customers), and a ratio of a total purchase amount by customers based on the rank to the total purchase amount by all customers (ratio of the amount of money). The aggregated information illustrated in FIG. 13 is shown in the form of a table. The display mode of the aggregated information is not limited to the examples of FIGS. 12 and 13, and an appropriate display mode (display configuration) in consideration of clarity and the like may be used.

The output unit 17 may further output information such as attribute information about the customer to the terminal device 20 according to a request. The attribute information about the customer output to the terminal device 20 is displayed on the display device 21 in a form of a table, for example.

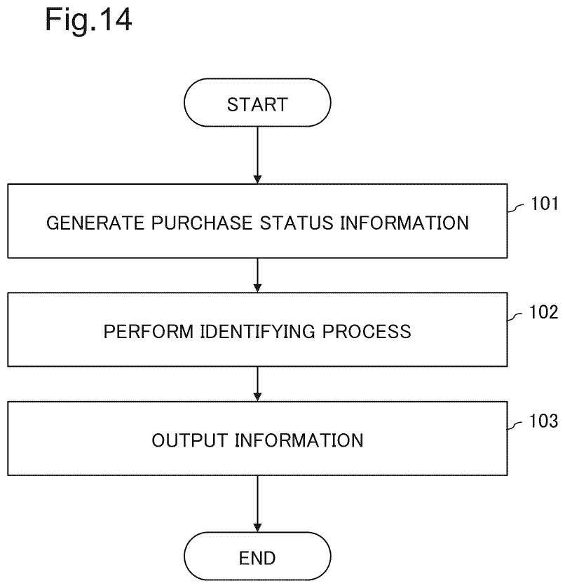

The purchase action analysis apparatus 1 of the first example embodiment has the above-described configuration. Next, an example of an operation related to the analysis processing of the purchase action in the purchase action analysis apparatus 1 will be described with reference to a flowchart of FIG. 14. FIG. 14 is also a diagram illustrating an example of a purchase action analysis method in the purchase action analysis apparatus 1.

For example, it is assumed that purchase history information of a customer at a store of interest is stored in the database 50. In such a situation, triggered by the purchase action analysis apparatus 1 receiving an analysis start command from the terminal device 20, the generation unit 13 generates the purchase status information (step 101). The generation unit 13 calculates the total purchase amount in each analysis unit period for each customer using the purchase history information about the customer at the store of interest, and generates information including history information of the total purchase amount as the purchase status information. The generation unit 13 calculates the number of purchases in each analysis unit period, and includes information about the number of purchases in the purchase status information. Further, the generation unit 13 ranks each customer in each analysis unit period, and includes information about the rank determined by this in the purchase status information. Using such information about the rank, grouping of customers is performed using a change tendency of the rank.

Thereafter, for example, for the analysis unit period designated using the terminal device 20 as the analysis target, the identification unit 15 identifies the change factor of the group whose purchase status has changed by, for example, the change factor identification model using the purchase history information and the purchase status information about the customers, thereby identifying the change factor in the analysis unit period of the customers of the group (step 102). Further, the identification unit 15 may identify the purchase factor in the sectional period set in the analysis unit period. The identified information is stored in the database 50.

Thereafter, when a request for providing information is received from the terminal device 20, the output unit 17 reads information including a change factor according to the request from the database 50, and returns (outputs) the read information as change factor information to the terminal device 20 that is a transmission source of the information provision request (step 103). At this time, in a case where the providing information about the purchase factor is also requested, the output unit 17 reads the information about the purchase factor according to the request from the database 50 to output the read information as the purchase factor information to the terminal device 20 that is the transmission source of the information provision request. The change factor information and the purchase factor information output to the terminal device 20 as described above are displayed on the screen of the display device 21.

The purchase action analysis apparatus 1 of the first example embodiment is configured to identify, as a change factor, a product or a product classification that is a factor of a change in which a purchase status is changed using purchase history information and purchase status information, and output change factor information indicating the identified change factor. It can also be said that the change factor information is information indicating a product or a product classification mainly involved in the change in the purchase action of the customer (the entity who has purchased the product) in the analysis unit period. Such information is useful information when considering a marketing strategy, and is considered to be able to contribute to promoting the deployment of the marketing strategy.

The purchase action analysis apparatus 1 of the first example embodiment has a configuration capable of identifying the purchase factor information. The purchase factor information can be said to be information indicating a purchase pattern focusing on a change (in other words, the time-series change of the key driver product) in a purchased product purchased by the customer in an analysis unit period, and is information indicating a customer's purchase action in more detail. Such information is also useful when considering the development of a marketing strategy.

### <Modification of Output Destination>

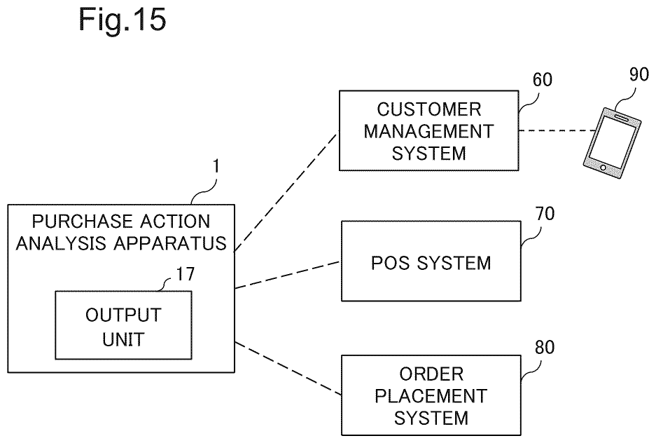

In the above-described example, the terminal device 20 is exemplified as a destination to which the output unit 17 outputs information. The output destination to which the output unit 17 outputs information is not limited to the terminal device 20, and may be the following output destination. For example, as illustrated in FIG. 15, the output unit 17 may output information to a customer management system 60, a point of sales (POS) system 70, or an order placement system 80.

The customer management system 60 is a system that manages customers who are general consumers, for example, and also has a function as a marketing system, for example. The customer management system 60 executes, for example, a marketing strategy (sales promotion measure) using the information output from the output unit 17. Examples of the marketing strategy include generating (selecting) information for sales promotion suitable for the customer using the information output from the output unit 17 and displaying the information about the customer's mobile terminal 90, and transmitting an e-mail for sales promotion to the customer.

The POS system 70 is a system that manages information at the time when a product of a retail store is sold, and includes a POS terminal. In the POS system 70, for example, information output from the output unit 17 of the purchase action analysis apparatus 1 is used for selection of a target product of a coupon ticket issued from a POS terminal, determination of message content for sales promotion to be conveyed to a store clerk using the POS terminal, and the like.

The order placement system 80 is a system that is connected to a retail store and executes processing related to ordering of a product. In the order placement system 80, for example, the information output from the output unit 17 of the purchase action analysis apparatus 1 is used in the processing of determining the order quantity of the product.

As described above, the customer management system 60, the POS system 70, and the order placement system 80 are configured to execute processing related to sales promotion and order placement using the information output from the output unit 17 of the purchase action analysis apparatus 1. In other words, it can be said that sales promotion and order placement processing in the customer management system 60, the POS system 70, and the order placement system 80 are controlled using the information output from the output unit 17 of the purchase action analysis apparatus 1.

### <Modification of Identifying Process in Identification Unit>

In the above-described example, the identification unit 15 identifies a change factor and a sales factor using the AI technology. Alternatively, the identification unit 15 may identify a change factor or a sales factor using statistical processing. For example, in this case, an example of the statistical processing includes cross-tabulation of items such as attribute information of customers such as age, a selling area and a product.

### Second Example Embodiment

Hereinafter, the second example embodiment according to the present disclosure will be described. In the description of the second example embodiment, the same reference numerals are assigned to the same names as the names assigned with the reference numerals used in the description of the first example embodiment, and redundant description thereof will be omitted.

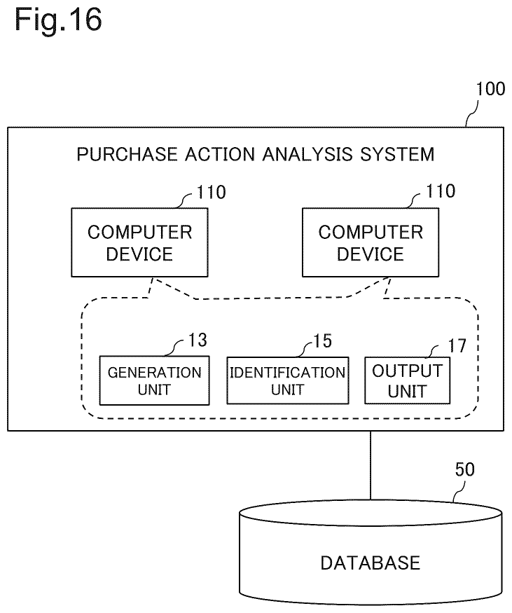

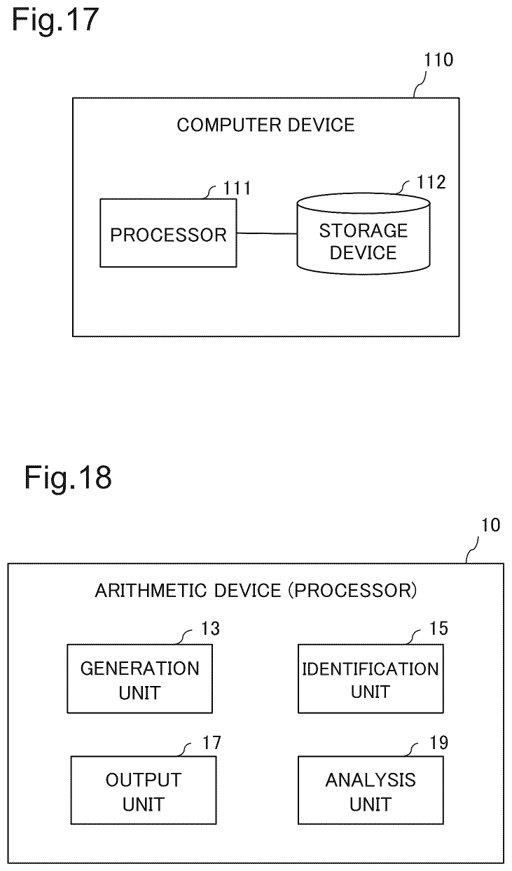

As illustrated in FIG. 16, a purchase action analysis system 100 according to the second example embodiment includes a plurality of computer devices 110. As illustrated in FIG. 17, the computer device 110 includes a processor 111 and a storage device 112. The processor 111 and the storage device 112 have configurations similar to those of the arithmetic device (processor) 10 and the storage device 30 described in the first example embodiment, respectively. That is, the processor 111 can have a function related to the program by executing the program stored in the storage device 112. In the example of FIG. 16, two computer devices are illustrated as the computer devices 110 constituting the purchase action analysis system 100, but the number of computer devices 110 constituting the purchase action analysis system 100 is not limited as long as it is plural.

The purchase action analysis system 100 in the second example embodiment has functions similar to those of the generation unit 13, the identification unit 15, and the output unit 17 described in the first example embodiment. In the purchase action analysis system 100 of the second example embodiment, a plurality of computer devices 110 executes processing in a distributed manner in order to implement the functions of the generation unit 13, the identification unit 15, and the output unit 17. An allocation method and an allocation content for determining to which of the plurality of respective computer devices 110 the plurality of processes for implementing the functions of the generation unit 13, the identification unit 15, and the output unit 17 is to be allocated are not limited herein, and description thereof will be omitted.

The purchase action analysis system 100 of the second example embodiment has a configuration that implements the functions of the generation unit 13, the identification unit 15, and the output unit 17 described in the first example embodiment using a plurality of computer devices 110. That is, the purchase action analysis system 100 of the second example embodiment has the functions of the generation unit 13, the identification unit 15, and the output unit 17 as in the first example embodiment, and thus can achieve effects similar to those of the first example embodiment.

### Other Example Embodiments

The present disclosure is not limited to the first example embodiment and the second example embodiment, and various example embodiments can be used. For example, one or both of the analysis unit period and the sectional period may be set using the AI technology. For example, the change tendency of the purchase action may be detected by the AI technology from the purchase history information of all customers in the store of interest, and the analysis unit period or the sectional period may be set by the computer from the detected change tendency.

In addition to the configurations of the first example embodiment and the second example embodiment, the following configuration may be further provided. That is, an analysis unit 19 as illustrated in FIG. 18 may be provided. The analysis unit 19 identifies a feature of persons (customers) who have purchased the product or the product in the product classification to be analyzed using attribute information of a customer (entity) who has purchased the product or the product in the product classification to be analyzed (for example, a sales promotion product or a product in a sales promotion product classification). An example of a method of identifying the feature of customers includes a method using a model (hereinafter, also referred to as a feature identification model) generated by an AI technology. The feature identification model is, for example, a model has learned data in which attribute information of an entity (customer) who has purchased a product or a product in a product classification to be analyzed is associated with information as to whether the entity (customer) has purchased the product to be analyzed or the product in the product classification. The input to the model is information indicating a product or a product classification to be analyzed, and the output from the model is information indicating the feature of persons (customers) who has purchased the product or product in the product classification to be analyzed.

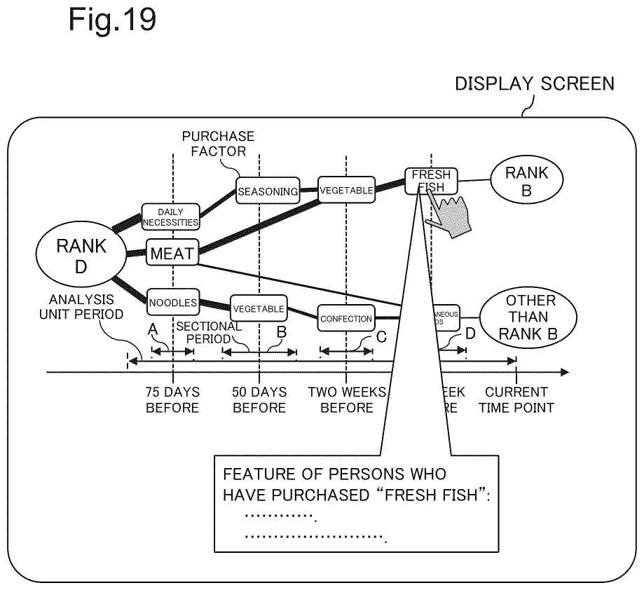

In a case where the analysis unit 19 is provided, the output unit 17 outputs information (purchaser feature information) indicating an analysis result by the analysis unit 19 according to a request (information request). For example, it is assumed that information about a product classification that is a purchase factor as illustrated in FIG. 19 is displayed on the display device 21 of the terminal device 20. In this case, for example, it is assumed that “fresh fish” is designated by the user as the product classification to be analyzed using the screen display. In response to the designated “fresh fish” being output from the terminal device 20 as information indicating the product classification to be analyzed, the output unit 17 returns, to the terminal device 20, information indicating the feature of customers who have purchased the product classification “fresh fish” to be analyzed, the information having been analyzed by the analysis unit 19. That is, the output unit 17 returns, to the terminal device 20, the purchaser feature information related to the information request for requesting the information indicating the feature of persons who have purchased the product classification “fresh fish”. As a result, the feature of customers who have purchased the product classification “fresh fish” to be analyzed is displayed on the display device 21 of the terminal device 20.

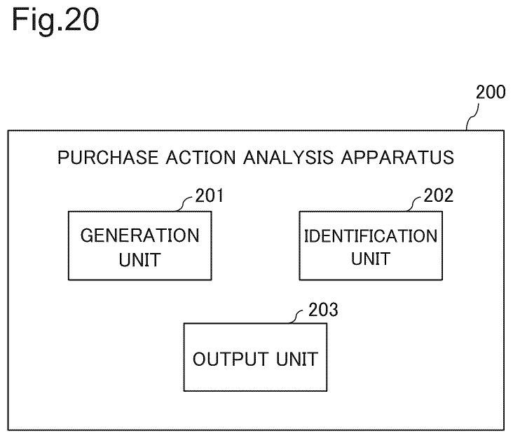

The purchase action analysis apparatus according to the present disclosure may have a configuration illustrated in FIG. 20, for example, as another example embodiment. That is, a purchase action analysis apparatus 200 of another example embodiment includes a generation unit 201, an identification unit 202, and an output unit 203. Using purchase history information including an entity who has purchased the product, a timing at which the product has been purchased, and a purchase amount of the product, the generation unit 201 generates purchase status information including information about a total purchase amount that is a total amount of one or more purchase amounts of the entity in each analysis unit period. Using the purchase history information and the purchase status information, the identification unit 202 identifies, as a change factor, a product or a product classification that is a factor of a change in the purchase status of the entity whose purchase status has changed. The output unit 203 outputs change factor information indicating the identified change factor.

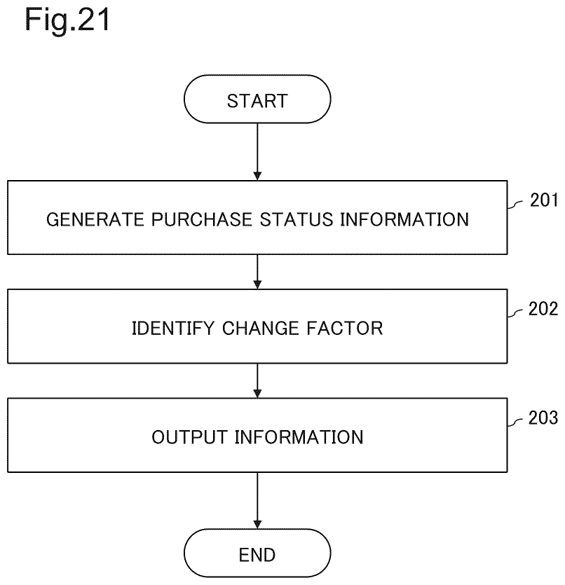

Next, an example of an operation of the purchase action analysis processing in the purchase action analysis apparatus 200 will be described with reference to FIG. 21. It can also be said that FIG. 21 is a diagram for describing the purchase action analysis method by the purchase action analysis apparatus 200.

For example, using purchase history information including an entity who has purchased a product, a timing at which the product has been purchased, and a purchase amount of the product, the generation unit 201 generates the purchase status information including the information about the total purchase amount that is the total amount of the purchase amount of the entity in each analysis unit period (step 201). The identification unit 202 identifies, as a change factor, a product or a product classification that is a factor of a change in the purchase status of the entity whose purchase status has changed, using the purchase history information and the generated purchase status information after the purchase status information is generated in this manner (step 202). The output unit 203 outputs change factor information indicating the identified change factor (step 203).

As described above, the purchase action analysis apparatus 200 is configured to generate the purchase status information and identify, as a change factor, the product or the product classification that is a factor of a change in the purchase status of the entity whose purchase status has changed. That is, the purchase action analysis apparatus 200 can provide information focusing on a product or a product classification that affects the purchase action, instead of information such as the simple purchase amount and the number of purchases of an entity (for example, a customer). In other words, the purchase action analysis apparatus 200 can provide information from a new viewpoint that can contribute to planning of a marketing strategy.

Some or all of the above example embodiments may be described as the following Supplementary Notes, but are not limited to the following.

### [Supplementary Note 1]

A purchase action analysis apparatus including
a memory configured to store instructions, and
at least one processor configured to execute the instructions to
generate, using purchase history information including an entity who has purchased a product, a timing at which the product has been purchased, and a purchase amount of the product, purchase status information including information about a total purchase amount that is a total amount of one or more purchase amounts of the entity in each analysis unit period,
identify, as a change factor, a product or a product classification that is a factor of a change in a purchase status of an entity whose purchase status has changed, using the purchase history information and the purchase status information, and
output change factor information representing the identified change factor.

### [Supplementary Note 2]

The purchase action analysis apparatus according to Supplementary Note 1, wherein
the at least one processor is further configured to execute the instructions to
identify, as a purchase factor, a product or a product classification estimated to have led to a purchase action of an entity in each of a plurality of sectional periods set in the analysis unit period, and
output, as purchase factor information, information indicating a purchase factor in each sectional period in the analysis unit period as in such a way as to be displayed on a display device.

### [Supplementary Note 3]

The purchase action analysis apparatus according to Supplementary Note 1 or 2, wherein
the at least one processor is further configured to execute the instructions to identify the change factor using a change factor identification model that receives at least the purchase history information and the purchase status information to output information about the change factor, and
the change factor identification model is generated by learning purchase history information about a plurality of entities whose purchase status indicates a noted change and purchase history information about a plurality of entities whose purchase status indicates a change other than the noted change.

### [Supplementary Note 4]

The purchase action analysis apparatus according to any one of Supplementary Notes 1 to 3, wherein
the at least one processor is further configured to execute the instructions to identify, using attribute information of an entity who has purchased a product or a product in a product classification to be analyzed, a feature of a person who has purchased the product or the product in the product classification to be analyzed, and
the at least one processor is further configured to execute the instructions to output, in response to an information request for requesting purchaser feature information indicating a feature of a person who has purchased the product, the purchaser feature information about a purchaser who has purchased the product or the product in the product classification to be analyzed.

### [Supplementary Note 5]

The purchase action analysis apparatus according to Supplementary Note 2, wherein
the purchase factor information includes information for display, on a display device, a purchase factor time series pattern in which purchase factors in respective sectional periods in the analysis unit period are disposed in time series.

### [Supplementary Note 6]

The purchase action analysis apparatus according to Supplementary Note 5, wherein
the purchase factor information includes information indicating the number of entities having the same combination of adjacent purchase factors in the purchase factor time series pattern.

### [Supplementary Note 7]

The purchase action analysis apparatus according to Supplementary Note 2, wherein
the at least one processor is further configured to execute the instructions to identify, using attribute information about an entity who has purchased a product or a product in a product classification to be analyzed, a feature of a person who has purchased the product or the product in the product classification to be analyzed, and
the at least one processor is further configured to execute the instructions to output purchaser feature information in response to an information request for requesting information indicating a feature of a person who has purchased a product that is a purchase factor displayed on the display device.

### [Supplementary Note 8]

A purchase action analysis method executed by a computer, the method including
generating, using purchase history information including an entity who has purchased a product, a timing at which the product has been purchased, and a purchase amount of the product, purchase status information including information about a total purchase amount that is a total amount of one or more purchase amounts of the entity in each analysis unit period,
identifying, as a change factor, a product or a product classification that is a factor of a change in a purchase status of an entity whose purchase status has changed, using the purchase history information and the purchase status information, and
outputting change factor information representing the identified change factor.

### [Supplementary Note 9]

A non-transitory computer readable medium storing a computer program for causing a computer to execute the steps of
generating, using purchase history information including an entity who has purchased a product, a timing at which the product has been purchased, and a purchase amount of the product, purchase status information including information about a total purchase amount that is a total amount of one or more purchase amounts of the entity in each analysis unit period,
identifying, as a change factor, a product or a product classification that is a factor of a change in a purchase status of an entity whose purchase status has changed, using the purchase history information and the purchase status information, and
outputting change factor information representing the identified change factor.

Some or all of the configurations described in Supplementary Notes 2 to 7 dependent on the above-described Supplementary Note 1 can also be dependent on each of Supplementary Notes 8 and 9 by the same dependency relationship as that of Supplementary Notes 2 to 7. Furthermore, some or all of the configurations described as the Supplementary Notes can be similarly dependent on not only the Supplementary Notes 1, 8, and 9, but also various pieces of hardware and software, and various recording means or systems for recording software without departing from the above-described example embodiments.

While the present disclosure has been particularly shown and described with reference to each of example embodiments, the present disclosure is not limited to the above example embodiments. Various modifications that can be understood by those of ordinary skill in the art can be made to the configuration and details of the present disclosure within the scope of the present disclosure. Each exemplary embodiment can be appropriately combined with another exemplary embodiment.

1. A purchase action analysis apparatus comprising:
a memory configured to store instructions; and
at least one processor configured to execute the instructions to:
generate, using purchase history information including an entity who has purchased a product, a timing at which the product has been purchased, and a purchase amount of the product, purchase status information including information about a total purchase amount that is a total amount of one or more purchase amounts of the entity in each analysis unit period;
identify, as a change factor, a product or a product classification that is a factor of a change in a purchase status of an entity whose purchase status has changed, using the purchase history information and the purchase status information; and
output change factor information representing the identified change factor.

2. The purchase action analysis apparatus according to claim 1, wherein
the at least one processor is further configured to execute the instructions to:
identify, as a purchase factor, a product or a product classification estimated to have led to a purchase action of an entity in each of a plurality of sectional periods set in the analysis unit period; and
output, as purchase factor information, information indicating a purchase factor in each sectional period in the analysis unit period in such a way as to be displayed on a display device.

3. The purchase action analysis apparatus according to claim 1, wherein
the at least one processor is further configured to execute the instructions to identify the change factor using a change factor identification model that receives at least the purchase history information and the purchase status information to output information about the change factor, and
the change factor identification model is generated by learning purchase history information about a plurality of entities whose purchase status indicates a noted change and purchase history information about a plurality of entities whose purchase status indicates a change other than the noted change.

4. The purchase action analysis apparatus according to claim 1, wherein
the at least one processor is further configured to execute the instructions to identify, using attribute information of an entity who has purchased a product or a product in a product classification to be analyzed, a feature of a person who has purchased the product or the product in the product classification to be analyzed, and
the at least one processor is further configured to execute the instructions to output, in response to an information request for requesting purchaser feature information indicating a feature of a person who has purchased the product, the purchaser feature information about a purchaser who has purchased the product or the product in the product classification to be analyzed.

5. The purchase action analysis apparatus according to claim 2, wherein
the purchase factor information includes information for display, on a display device, a purchase factor time series pattern in which purchase factors in respective sectional periods in the analysis unit period are disposed in time series.

6. The purchase action analysis apparatus according to claim 5, wherein
the purchase factor information includes information indicating the number of entities having the same combination of adjacent purchase factors in the purchase factor time series pattern.

7. The purchase action analysis apparatus according to claim 2, wherein
the at least one processor is further configured to execute the instructions to: identify, using attribute information about an entity who has purchased a product or a product in a product classification to be analyzed, a feature of a person who has purchased the product or the product in the product classification to be analyzed, and
the at least one processor is further configured to execute the instructions to: output purchaser feature information in response to an information request for requesting information indicating a feature of a person who has purchased a product that is a purchase factor displayed on the display device.

8. A purchase action analysis method executed by a computer, the method comprising:
generating, using purchase history information including an entity who has purchased a product, a timing at which the product has been purchased, and a purchase amount of the product, purchase status information including information about a total purchase amount that is a total amount of one or more purchase amounts of the entity in each analysis unit period;
identifying, as a change factor, a product or a product classification that is a factor of a change in a purchase status of an entity whose purchase status has changed, using the purchase history information and the purchase status information; and
outputting change factor information representing the identified change factor.

9. A non-transitory computer readable medium storing a computer program for causing a computer to execute the steps of:
generating, using purchase history information including an entity who has purchased a product, a timing at which the product has been purchased, and a purchase amount of the product, purchase status information including information about a total purchase amount that is a total amount of one or more purchase amounts of the entity in each analysis unit period;
identifying, as a change factor, a product or a product classification that is a factor of a change in a purchase status of an entity whose purchase status has changed, using the purchase history information and the purchase status information; and
outputting change factor information representing the identified change factor.
